(19) United States
(12) Patent Application Publication
(10) Pub. No.: US 2005/0075146 A1
(43) Pub. Date: Apr. 7, 2005

(54) Apparatus and method for powering wireless inter-component audio transmission

(76) Inventor: Jason D. Kridner, Houston, TX (US)

Correspondence Address: TEXAS INSTRUMENTS INCORPORATED, P O BOX 655474, M/S 3999, DALLAS, TX, 75265, US

(21) Appl. No.: 10/680,770

(22) Filed: Oct. 7, 2003

(51) Int. Cl. H04M 1/00; H04B 1/38

(52) U.S. Cl. 455/572; 455/556.1

(57) ABSTRACT

In order to power the components providing wireless audio transmission from an audio signal source unit, the audio signal source uses the audio signal itself, after rectification and demodulation, to provide power to the components providing the wireless signal. Similarly, for an audio receiving unit, the power provided by the microphone pickup voltage can be used to detect and demodulate the wireless signal. These audio components can therefore be provided with wireless capability without requiring an external power source.

### 1. FIELD OF THE INVENTION

This invention relates to audio systems and, more particularly, to the wireless transmission of audio signals between components of an audio system.

### 2. BACKGROUND OF THE INVENTION

Referring to FIG. 1, an audio system 10 according to the prior art is shown. The audio system 10 includes an audio signal source 11 and audio signal receiver 12. The audio system console 11 and the speakers 12 are connected by cable/leads 15. The cable/leads 15 have connecting portions 17 that typically engage the terminals of the audio signal source 11 and the audio signal receiver 12. The cable/leads 15 serve as the conduit over which the audio signals are transmitted.

For a variety of reasons, such as appearance or because of intervening obstacles, it can be desirable to eliminate the cable/leads shown in FIG. 1. Referring to FIG. 2, an audio system 20 can have audio source 21 with an internal electromagnetic generation unit powering a transmission antenna 25 and an audio signal receiver 22 having an internal unit for detecting/demodulating the signal received by the antenna 26. In this manner, an audio signal can be transmitted from the audio signal source 21 to the audio signal receiver 22 without being physically coupled by a cable/lead.

Because the internal signal generation apparatus in the audio source unit and the internal detection/ demodulation apparatus can provide an increase in cost and may not be a requirement for all consumers, it is desirable to make the wireless transmission between the audio signal source and the audio signal receiver optional. Referring to FIG. 3, the technique for providing optional wireless audio transmission capability is shown. A signal generating unit 31 is coupled to the output terminal(s) of the audio signal source 11. This unit 31 takes the audio output signal, modulates a transmitting electromagnetic spectrum signal, and transmits the modulated signal by means of antenna 32. Antenna 33 receives the transmitted signals, and applied the signal to detector/demodulator 34. The audio signal is now applied to the input terminals of audio signal receiver 12. The units 31/32 and 33/34 are detachable and can be used to replace the cable/lead 15. Note that both the signal generating unit 31 and the detector/demodulator unit 34 are active units and require power supplied through power leads 35 and 36. (In some prior art devices, antenna 32 and 33 are not used and the audio signal is used to modulate a electromagnetic signal that is transmitted though power lead 35, the power distribution system, and through power cable 36.)

Some situations occur, such as in portable audio systems, where receipt of power from a power distribution system is not convenient. It would be advantageous in these situations to eliminate power cords and provide power for the signal generating unit 31 and/or for the detection/demodulation unit 34 from an alternative source.

A need has therefore been felt for apparatus and an associated method having the feature that signal from an audio signal generating unit is coupled to an audio signal receiver without a cable/lead. It is another feature of the apparatus and associated method apparatus and associated method to transmit a modulated electromagnetic signal from a signal generating unit coupled to an audio signal source to a detection/demodulation unit of an audio signal receiver. It is a more particular feature of the apparatus and associated method to power the signal generating unit by the audio signal source to which it is coupled. It is yet another particular feature of the apparatus and associated method to power the detection/modulation unit by the audio signal receiver to which it is coupled.

### SUMMARY OF THE INVENTION

The aforementioned and other features are accomplished, according to the present invention, by powering the wireless transmitting element in an audio signal source unit with the audio signal itself. The audio signal is used both as a source of power for the modulation of a carrier signal, but also as the modulated signal. Similarly, in an audio signal receiver, the components detecting and demodulating the wireless signal can be powered by the microphone pickup voltage. When the voltage level is insufficient to power these components, a device such as a charge pump can be used to increase the voltage.

Other features and advantages of the present invention will be more clearly understood upon reading of the following description and the accompanying drawings and claims.

### BRIEF DESCRIPTION OF THE DRAWINGS

FIG. 1 is a block diagram of a first embodiment of an audio system according to the prior art.

FIG. 2 is a block diagram of a second embodiment of an audio system according to the prior art.

FIG. 3 is a block diagram of a third embodiment of an audio system according to the prior art.

FIG. 4 is a block diagram of the signal generation unit according to the present invention.

FIG. 5 is block diagram of detector/demodulator unit according to the present invention.

### DESCRIPTION OF THE PREFERRED EMBODIMENT

1. Detailed Description of the Drawings

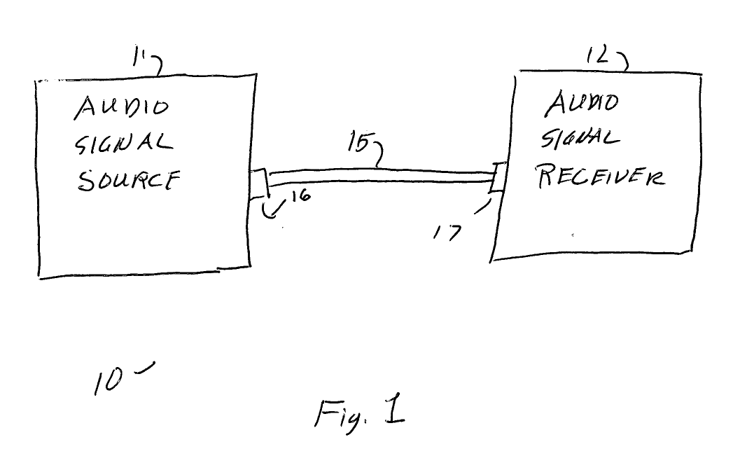

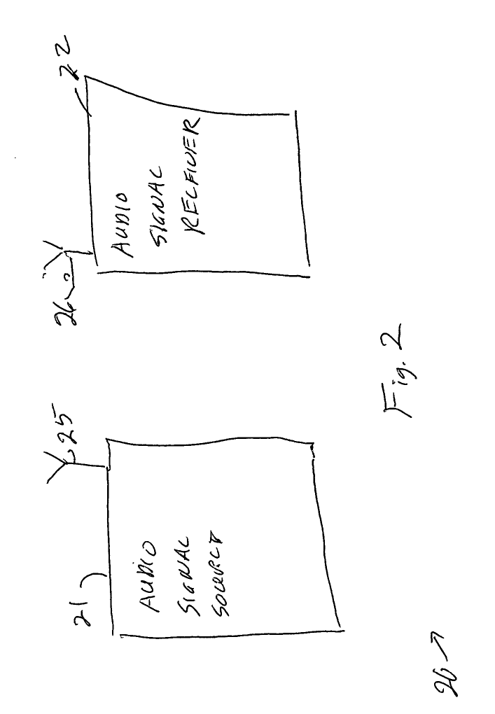

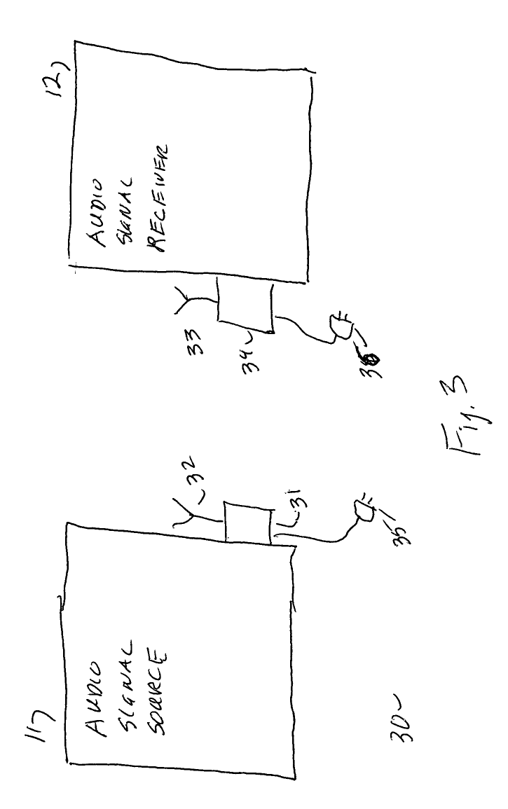

FIG. 1, FIG. 2, and FIG. 3 have been described with respect to the related art.

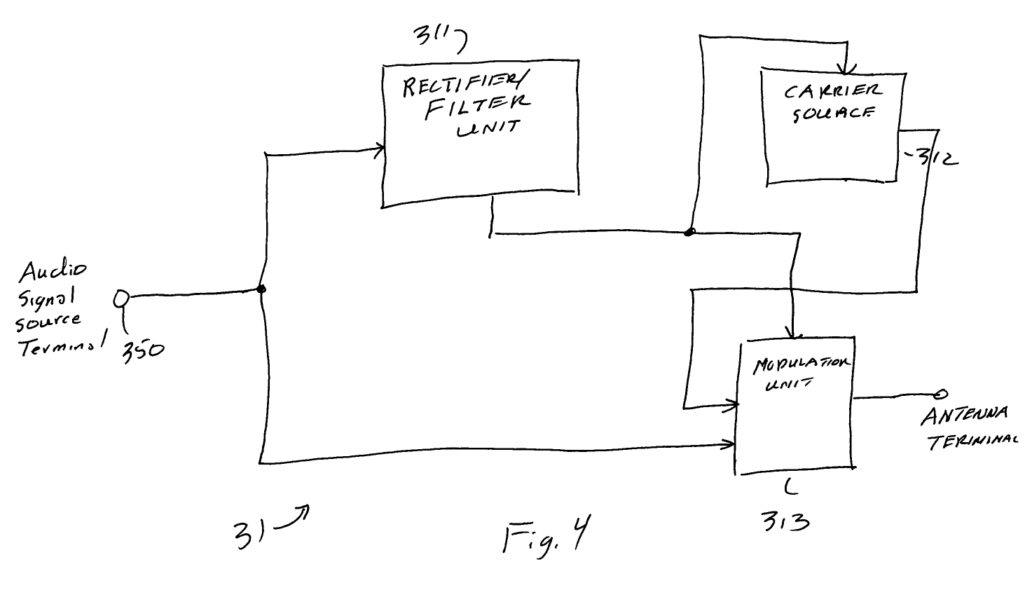

Referring to FIG. 4, a block diagram of a signal generation unit 31 is shown. The audio signal, applied to the audio signal output terminal 350, is coupled to the rectifier/filter unit 311. The rectifier/filter unit 311 acts as a dc power supply. The output voltage of the rectifier/filter unit 311 is used to provide a power source for the carrier source 312 and for the modulation unit 313. The carrier source 312 is typically an oscillator providing a (typically rf) carrier frequency signal. The carrier frequency signal from carrier source 312 is applied to the modulation unit 313. The carrier frequency is modulated with the applied audio frequency signal. The resulting modulated signal is then applied to the antenna 32 and transmitted to the audio signal receiver. The antenna 33 receives the modulated signal and applies this signal to the detector/demodulator 34. The detector/modulator 34 processes the modulated signal and extracts the audio component there from.

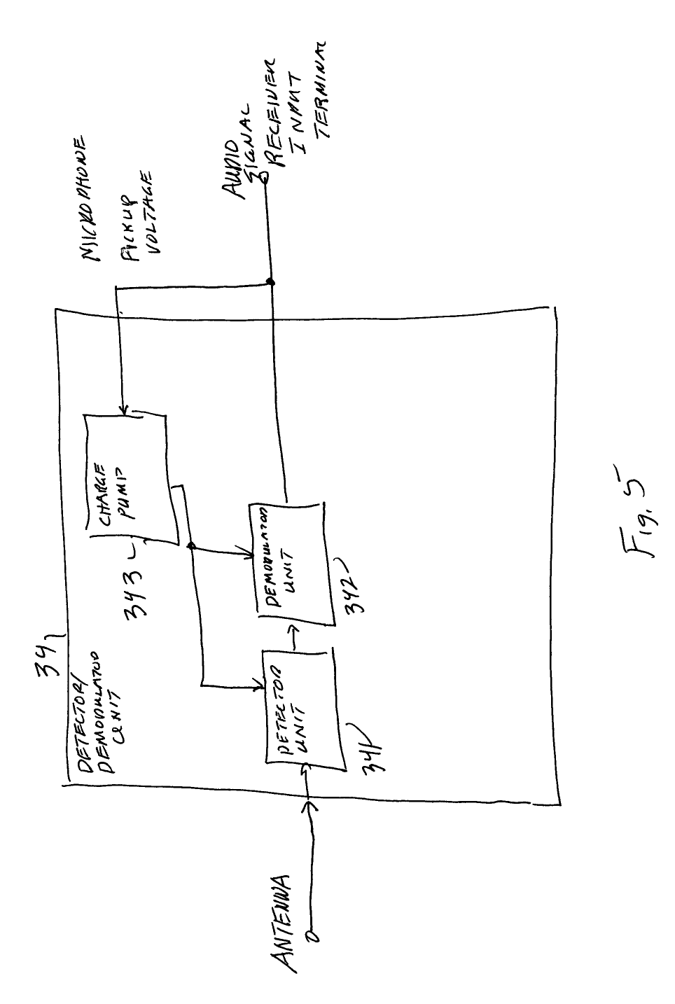

Referring to FIG. 5, a block diagram of the detector/demodulator unit is shown. A signal from antenna 33 is applied to the detection unit 341 of the detector/demodulator unit 34. After detection of the signal in detector unit 341, the resulting signal is applied to the demodulation 342. In the demodulation unit 342, the audio signal is extracted from the modulated signal. The audio signal is then applied to an input terminal of the audio signal receiver 34. In order to power the detector/ demodulator unit, the terminal of the audio receiver to which the microphone pickup voltage is applied is applied to a charge pump 343. The charge pump can increase the voltage level to powering the components of the detector/demodulator unit 34.

2. Operation of the Preferred Embodiment

The present invention permits the transmission of wireless signals between audio components without additional sources of power. In the case of the audio signal source, the power is supplied by the audio signal itself. The signal is rectified and filtered in the manner of a normal 60 cycle power supply. The voltage source obtained in this manner is used to power the apparatus generating the carrier signal and the apparatus modulating the carrier signal with the audio signal.

With respect to the audio receiving apparatus, the power for the detector unit and for the demodulation unit is provided by the microphone pickup voltage. While this voltage level may be insufficient for these components, the charge pump provides a technique for increasing this voltage level.

The use of the device power sources to power the wireless transmission of audio signal between components permits the wireless functionality to be incorporated without additional power sources. As will be clear, modern signal processing techniques have greatly reduced the power required to transfer wireless signals from one device to a second device. Improvements in power consumption of the component will continue to improve as the newer technologies evolve.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

1. A audio wireless signal generating unit, the unit comprising:
audio signal source generating an audio signal, and
a signal generating unit detachably coupled to the audio signal source, the signal generating unit including;
modulation component, the modulation component responsive to the audio signal for modulating a wireless signal therewith; and
a power supply responsive to the audio signal for generating a voltage, the voltage powering the modulation component.

2. The unit as recited in claim 1 wherein the power supply includes a rectifying component and a filtering component.

3. The unit as recited in claim 1 wherein the modulation component includes a carrier frequency component.

4. An audio signal receiving unit, the unit comprising:
an audio signal receiving component, the audio signal receiving component generating a microphone pickup voltage; and
a wireless receiving unit, the wireless receiving unit detecting and demodulating a wireless signal, the wireless receiving unit applying an audio signal to the audio signal receiving component, the wireless receiving unit being powered by the microphone pickup voltage.

5. The audio signal receiving unit as recited in claim 4 wherein the wireless receiving unit is detachably coupled to the audio signal receiving unit.

6. The audio signal receiving unit as recited in claim 4 wherein the wireless receiving unit includes a charge pump, the charge pump increasing the microphone pickup voltage level.

7. The method of powering a device generating a wireless signal modulated with an audio signal, the method comprising using a portion of the audio signal to provide power to the device.

8. The method as recited in claim 7 wherein the using step includes rectifying and filtering the portion of the audio signal.

9. An audio system, the system comprising:
an audio signal source, the audio signal source generating an audio signal;
a wireless transmission unit receiving the audio signal, the wireless transmission unit modulating a carrier signal with the audio signal, wherein the wireless transmission unit is powered by the audio signal; and
an audio signal receiver, the audio receiver separating the audio signal from the carrier signal.

10. The system as recited in claim 9 wherein the separation of the audio signal from carrier signal is performed in a wireless receiver unit, the wireless receiver unit being detachable from the audio signal receiver, the wireless receiver unit being powered by a microphone pickup voltage.

11. In a audio receiver unit in which a wireless receiving unit is detachably coupled to an audio signal receiver, the method of powering the wireless receiving unit, the method comprising:
powering the wireless receiver unit with a microphone pickup voltage from the audio signal receiver.
